(19) United States
(12) Patent Application Publication
(10) Pub. No.: US 2007/0260688 A1
(43) Pub. Date: Nov. 8, 2007

(54) Method of determining a refund on a communications network

(76) Inventors: Andrew Franklin Robinson, Auckland (NZ); Yong Chen, Auckland (NZ)

Correspondence Address: YOUNG & THOMPSON, 745 SOUTH 23RD STREET, 2ND FLOOR, ARLINGTON, VA, 22202, US

(21) Appl. No.: 11/642,620

(22) Filed: Dec. 21, 2006

(30) Foreign Application Priority Data
Dec. 23, 2005 (NZ) 544412

(51) Int. Cl. G06F 15/16

(52) U.S. Cl. 709/204

(57) ABSTRACT

A method of determining a refund on a communications network The method comprises the steps of allowing a user to request responses to a query through the medium of the communications network in return for a fee paid by the user. A selected time the request for responses terminates, and a determination is made of whether to give a refund to the user. The determination is based or a criterium on criteria independent of the user.

This invention relates to a method of determining a refund on a communications network and has been devised particularly though not necessarily solely for use in conjunction with the internet.

Many communications networks, such as the internet, allow customers, or users, to offer money (or points) on a request, or bid for information or other services. For example, the customer may “attach” US$10 to a request, and then wait for a Knowledge or Service Provider (KSP) to reply to the request. If the KSP delivers the knowledge or service before payment is made, there's a risk to the KSP that the customer may take the knowledge or service without paying.

Therefore, on a knowledge/service sharing network, in order for the KSP to feel confident in sharing information, the customer must make a payment first. However, when a payment is made before the KSP delivers the knowledge or service, there's a risk to the customer that the knowledge or service provided may not be satisfactory. If so, the customer may want a refund, or partial refund which will have to be negotiated with the KSP. At the moment no method exists to determine whether or not a refund is appropriate, and if so, what the appropriate amount of refund might be.

It is therefore an object of the present invention to provide a method of determining a refund on a communications network which will obviate or minimise the foregoing disadvantages in a simple yet effective manner or which will at least provide the public with a useful choice.

The discussion herein of the background to the invention is included to explain the context of the invention. This discussion is not an admission that any of the material referred to was published, known or part of the common general knowledge at the priority date of any of the claims.

Accordingly in one aspect the invention consists in a method of determining a refund on a communications network, comprising the steps of allowing a user to request responses to a query through the medium of the communications network in return for a fee paid by the user, at a selected time the request for responses terminating, and determining a refund if any to the user based or a criterium on criteria independent of the user.

Preferably the criterium or the criteria are also independent of the person or persons responding to the request.

Preferably the criterium or criteria comprises consideration of one or more of the written responses to the query, and the quality of those responses.

Preferably the criterium or criteria compares the number and quality of responses with the expected number or/quality of responses.

Preferably the criterium or criteria further includes the quality of the request.

Preferably the time of termination of the request may be selected by the user.

Alternatively the request may terminate by the effluxtion of time.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings which are possible graphical interfaces for use with the invention.

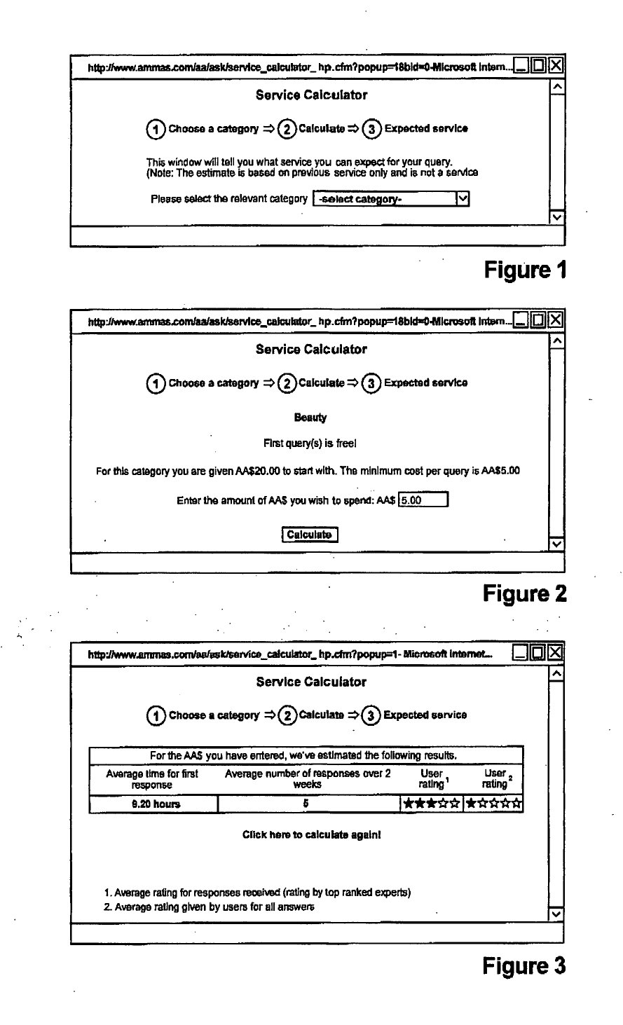

FIG. 1 being a type of opening graphical user interface (gui) for use in the method of the invention,

FIG. 2 is a page associated with the gui of FIG. 1,

FIG. 3 is a gui for use in the invention to enable a user to determine whether they wish to submit the request,

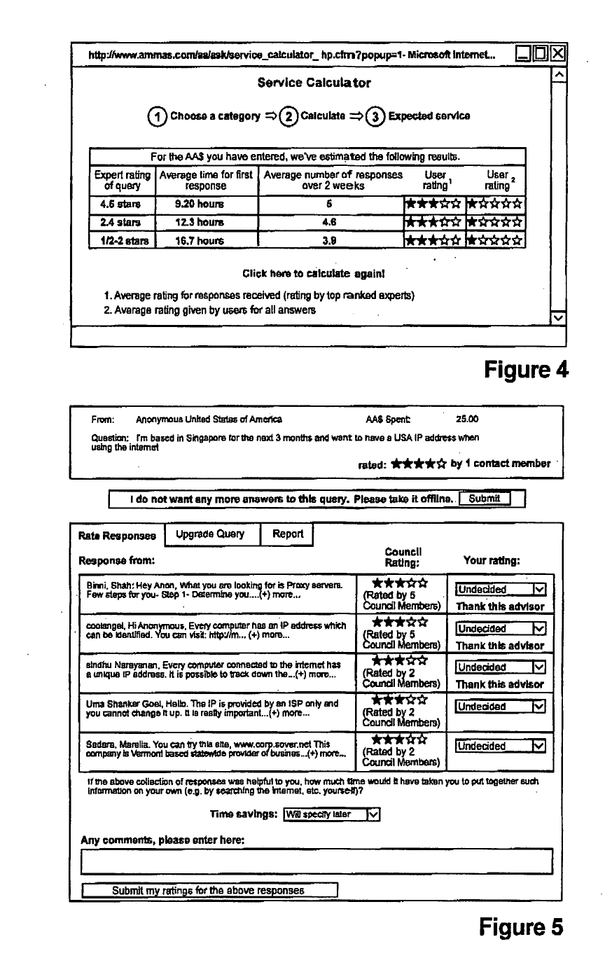

FIG. 4 is a gui to provide information to the user as to the expected service or a response,

FIG. 5 is a gui showing the query and responses along with other information, and

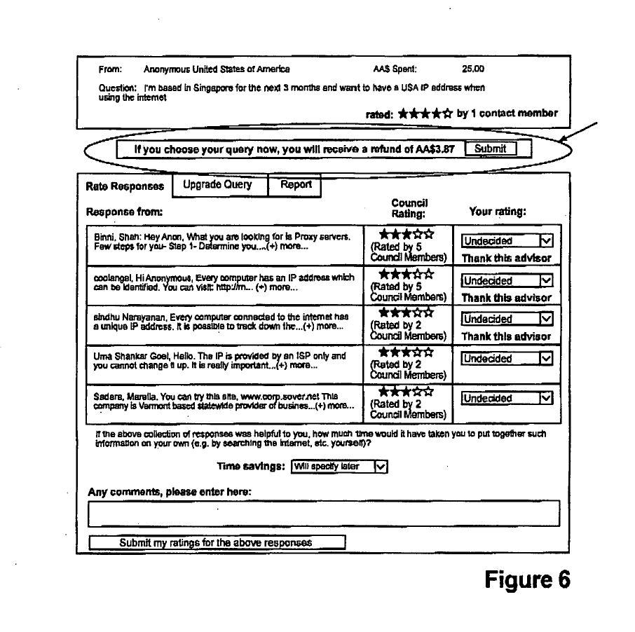

FIG. 6 is a gui as for FIG. 5 but indicating a refund option according to the present invention.

This invention relates to a method of determining a refund on a communications network such as the internet. The invention sets an expectation for the customer before payment is made, and then determines, based on results as described below, whether or not a refund is appropriate, and if so, what amount the refund should be. Put another way, the invention provides a method by which online users (or customers) of a knowledge/service sharing network in which points (or money) is “attached” to a request to feel confident they will not overpay for the knowledge or serviced received.

The preferred form of the invention is based on a number of assumptions.
1) The invention assumes customers can attach “points” or money to their request for services or knowledge on the network.
2) The invention assumes that the network allows multiple responses to a single request.
3) The invention assumes the network comprises a community of users involved in rating and/or assessing information and that these users are provided with an incentive to participate in such a way that the information is rated or assessed within a given timeframe (say, for example, two weeks).
4) We also assume at least three different participants in the transaction: (a) the customer, user or buyer of the knowledge or service, (b) the provider of the knowledge or service, what we call the KSP, and (c) an independent person or panel, what we call a Spontaneous Third Party Jury (SPERJ).

Initially the invention first gives the customers or user an estimate of service based on all, or a combination of, the following criteria:
What type of request
How many “points” or how much money the customer is “attaching” to the request
How the request is rated by the SPERJ, using for example a rating scale, such as a 1 to 5 rating scale with or without part stars such as half stars.

The last criteria is determined after the request is submitted.

FIG. 1 shows by way of example, the “Service Calculator” currently used on our Ammas.com and AskAgent.com website enhanced to commence the method of the invention. It takes into account the type of request (or category), and advises that the service expected in a selected category for the query to be asked. “Choose a Category” is highlighted.

FIG. 2 shows the amount of AA$ intended to be “attached” to, or spent on, the query and also shows the category of the request as selected by the intending user. “Calculate” is highlighted.

FIG. 3 shows the service calculator having processed the information provided on the FIG. 2 page, providing an estimate—or “Expected Service”—for the customer. “Expected Service” is highlighted. The estimate includes;
Average time for first response
Average number of responses over a given period of time
Average rating given by SPERJ as defined herein to the response(s)

The customer can then decide whether or not it's worth submitting the request. The fourth column in FIG. 3—User Rating—is optional to this invention. The “expert” rating is of responses from answer provides as a rate by a panel such as SPERJ whilst the user ratings are ratings given by users for answers to queries in the selected category. This information is generated from historical records.

The Service Calculator shown in FIG. 3 does not include different estimates for different SPERJ ratings of the request.

This invention can however include as an option different estimates for different SPERJ ratings of the request. So the Service Calculator at this point with “Expected Service” highlighted could then look like the graphical user interface shown in FIG. 4.

This is the first column if the request is rated 4 to 5 stars then five replies could be expected over two weeks, the first reply being received in 9.20 hours with an expert rating of the responses of 3 stars. If the query is rated less the references will take longer and likely the references will be rated less. This information is generated from historical records.

The customer preferably has an option to cancel and seek a refund at anytime. Currently our system allows customers to cancel, or “take offline” their request at any time. However it does not offer an automatic refund.

Once the customer's request is submitted to the KSP along with payment, the SPERJ, if desired, can rate the request, and the rating is made visible to the customer.

If the customer closes the transaction before the knowledge or service is provided, the system can return the payment, or part of the payment (depending on expectation set with customer regarding this situation), and the query is immediately removed from the system, or flagged as “closed”.

Once a knowledge or service is provided to the customer, and the transaction is closed (either by the customer ending it, or the timeframe expiring), the system looks at the SPERJ's rating of the response and runs a simple calculation to determine Value Provided (VP).

So, for example, if the transaction is terminated (by either the customer or a time limit) and the expectation was set for
Average number of responses over a given period of time=7
Average rating given by SPERJ to the response(s)=3.5 stars

but the customer has received only 2 responses, with an average rating of 2.5 stars by the SPERJ, the system can calculate (by simple multiplication of the two values) the Value Provided (VP) at 5/24.5^{th} of the full value. So, for example, if the payment was US$10, the system could, at this point, refund US$8.96.

The system could further—but not necessarily—factor in the amount of time it took for the first response to arrive, weigh that against the expected amount of time, and adjust the refund amount.

The system could further—but not necessarily—factor in the number of ratings given by the SPERJ on the request and/or the response, such that, a lesser number of ratings weighs more or less in favour of the customer. Weighing it less in favour of the customer is a more likely scenario, as, statistically, a lesser number of raters give a less reliable average. The more ratings given, the more reliable is the SPERJ assessment. As more ratings come in, the refund amount could alter.

FIG. 5 shows how our current response page looks to the customer who has submitted a request for information.

FIG. 6 shows a response page with the present invention included.

The refund offer is not based on the customer's rating, but rather on the SPERJ assessment, and other objective factors such as number of responses and response times involved. Thus the factors are determined by a body independent of the user and the persons making the response.

Of course, if the value of the knowledge or service exceeds the expectations presented to the customer, no refund is offered.

Thus it can be seen with the invention and refinement of the SPERJ we can include the post-transaction assessment to determine value of the knowledge or service provided, in a manner which is fair and impartial to both sides of the transaction—the customer and the KSP. The more transparent the mechanisms involved, the more effective the system is likely to be.

1. A method of determining a refund on a communications network, comprising the steps of allowing a user to request responses to a query through the medium of the communications network in return for a fee paid by the user, at a selected time the request for responses terminating, and determining a refund if any to the user based or a criterium on criteria independent of the user.

2. A method as claimed in claim 1, wherein the criterium or the criteria are also independent of the person or persons responding to the request.

3. A method as claimed in either claim 1 wherein the criterium or criteria comprises consideration of one or more of the written responses to the query, and the quality of those responses.

4. A method as claimed in claim 1 wherein the criterium or criteria compares the number and quality of responses with the expected number of quality of responses.

5. A method as claimed in claim 4 wherein the criterium or criteria further includes the quality of the request.

6. A method as claimed in claim 1 wherein the time of termination of the request may be selected by the user.

7. A method as claimed in claim 1 wherein the request may terminate by the effluxtion of time.

8. A method as claimed in claim 2 wherein the criterium or criteria comprises consideration of one or more of the written responses to the query, and the quality of those responses.
